(19) United States
(12) Patent Application Publication
(10) Pub. No.: US 2006/0076871 A1
(43) Pub. Date: Apr. 13, 2006

(54) Vacuum tube with oxide cathode

(75) Inventors: George Gaertner, AACHEN (DE); David Barratt, Lancashire (GB); Christopher James Goodhand, Doncaster (GB); Detlef Raasch, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINLIJKE PHILIPS ELECTRONICS N.V., EINDHOVEN (NL)

(21) Appl. No.: 10/535,638

(22) PCT Filed: Nov. 14, 2003
(86) PCT No.: PCT/IB03/05180

§ 371 Date: May 20, 2005

(30) Foreign Application Priority Data
Nov. 23, 2002 (DE) 102 54 697.5

(51) Int. Cl. H01J 1/14; H01J 19/06; H01K 1/04

(52) U.S. Cl. 313/346 R

(57) ABSTRACT

A vacuum tube, in particular a cathode ray tube, equipped with at least one oxide cathode comprising a cathode carrier with a cathode base of a cathode metal and a cathode body with a cathode coating of an electron-emitting material that comprises an alkaline earth oxide, selected from the group formed by the oxides of calcium, strontium and 5 barium, and a sintering inhibitor.

The invention relates to a vacuum tube, in particular a cathode ray tube, equipped with at least one oxide cathode comprising a cathode carrier with a cathode base of a cathode metal and a cathode coating of an electron-emitting material containing an alkaline earth oxide selected from the group formed by the oxides of calcium, strontium and barium.

A cathode ray tube is composed of four functional groups:

electron beam generation in the electron gun,

beam focusing using electrical or magnetic lenses,

beam deflection to generate a raster, and

luminescent screen or display screen.

The functional group relating to electron beam generation comprises an electron-emitting cathode, which generates the electron current in the cathode ray tube and which is enclosed by a control grid, for example a Wehnelt cylinder having an apertured diaphragm on the front side.

An electron-emitting cathode for a cathode ray tube generally is a punctiform, heatable oxide cathode with an electron-emitting, oxide-containing cathode coating. If the oxide cathode is heated, electrons are evaporated from the electron-emitting coating into the surrounding vacuum. If the Wehnelt cylinder is biased with respect to the cathode, then the quantity of emergent electrons and hence the beam current of the cathode ray tube can be controlled. The quantity of electrons that can be emitted by the cathode coating depends on the work function of the electron-emitting material. Nickel, which is customarily used for the cathode base, has itself a relatively high work function. For this reason, the metal of the cathode base is customarily coated with another material, which mainly serves to improve the electron-emitting properties of the cathode base. A characteristic feature of the electron-emitting coating materials of oxide cathodes in cathode ray tubes is that they comprise an alkaline earth metal in the form of the alkaline earth metal oxide.

To manufacture an oxide cathode, for example, a suitably shaped sheet of a nickel alloy is coated with the carbonates of the alkaline earth metals in a binder preparation. During evacuation and bakeout of the cathode ray tube, the carbonates are converted to the oxides at temperatures of approximately 1000° C. After this, said cathode already supplies a noticeable emission current, however, said current is not yet stable. Next, an activation process is carried out. This activation process causes the originally non-conducting ion lattice of the alkaline earth oxides to be converted to an electronic semiconductor in that donor-type impurities are incorporated in the crystal lattice of the oxides. These impurities essentially consist of basic alkaline earth metal, for example calcium, strontium or barium. In addition, oxygen defects are formed. The electron emission and electron conduction of the oxide cathodes is based on an impurity mechanism or an emission of elementary barium at the surface of the oxide cathode. Said activation process serves to provide a sufficiently large quantity of excess, basic alkaline earth metal, which enables the oxides in the electron-emitting coating to supply the maximum emission current at a prescribed heating capacity. A substantial contribution to the activation process is made by the reduction of barium oxide to elementary barium by alloy constituents (“activators”) of the nickel in the cathode base.

For the function and the service life of an oxide cathode it is important that elementary alkaline earth metal is continuously dispensed. The reason for this being that the cathode coating continuously loses alkaline earth metal during the service life of the cathode. The cathode material partly evaporates slowly as a result of the high temperature at the cathode, and is partly sputtered off by the ion current in the cathode ray tube.

However, initially the basic alkaline earth metal is continuously dispensed by reduction of the alkaline earth oxide at the cathode metal or activator metal. Said dispension is reduced, however, when in the course of time a thin, yet high impedance sintered layer (interface) of alkaline earth silicate or alkaline earth aluminate forms between the cathode base and the electron-emitting material due to conversion of the activators. The service life is also influenced by the fact that the amount of activator metal in the nickel alloy of the cathode base becomes depleted in the course of time.

EP 0 482 704 A discloses an oxide cathode whose carrier is substantially made of nickel and coated with a layer of an electron-emitting material comprising alkaline earth metal oxide, barium and a rare earth metal, the number of rare earth metal atoms in the electron-emitting material with respect to the number of alkaline earth metal atoms being in the range from 10 to 500 ppm, and the rare earth metal atoms being essentially uniformly distributed over the upper part of the layer composed of an electron-emitting material.

In addition, DE 10045406 discloses a cathode ray tube equipped with at least one oxide cathode comprising a cathode carrier with a cathode base of a cathode metal and a cathode coating of an electron-emitting material with oxide particles, which oxide particles contain an alkaline earth oxide which is selected from the group of oxides formed by calcium, strontium and barium and which is doped with an oxide in a quantity of 120 to 500 ppm at the most, which oxide is selected from the oxides of scandium, yttrium, lanthanum, cerium, praseodymium, neodymium, samarium, europium, gadolinium, terbium, dysprosium, holmium, erbium, thulium, ytterbium and lutetium, and the electron-emitting material has an electric conductance of 3-10⁻³ Ω⁻¹ to 12.5-10⁻³ Ω⁻¹cm⁻¹.

The addition of rare earth metal oxides causes the work function of the oxide cathode to be improved, however, the service life of the oxide cathode is not increased.

It is an object of the invention to provide a vacuum tube, the beam current of which is uniform and remains constant for a long period of time, while said cathode ray tube can be reproducibly manufactured.

In accordance with the invention, this object is achieved by a vacuum tube equipped with at least one oxide cathode comprising a cathode carrier with a cathode base of a cathode metal and a cathode body with a cathode coating of an electron-emitting material that comprises an alkaline earth oxide, selected from the group formed by the oxides of calcium, strontium and barium, and a sintering inhibitor.

The invention is based on the basic idea that in a vacuum tube with an oxide cathode, the service life of said oxide cathode is increased by precluding not only the formation of a sinter layer at the cathode base, but also the slow co-sintering of all of the electron-emitting material as well as the migration and coagulation of the barium clusters during the application of the oxide cathodes.

In an amorphous electron-emitting material, the sintering inhibitor hampers the formation of crystallites and, in a crystalline electron-emitting material, it hampers the grain growth of the crystallites. The occurrence of a broad grain size distribution of the crystallites, and the occurrence of giant grains is thus precluded. Shrinkage and reduction of the specific surface and hence reduction of the quantity of barium covering the surface is precluded.

It is also precluded that, at an applied voltage, current paths can develop, which lead to local overloading resulting in the function of the component being adversely affected or even in destruction of said component.

A vacuum tube comprising such an oxide cathode exhibits a uniform beam current for a long period of time since, as a result of controlled and reduced sintering, the secondary pore structure in the oxide cathode, which has formed during decomposition of the carbonates in the manufacturing process, remains in tact.

As barium is dispensed continuously, depletion of the electron emission, as known from the oxide cathodes according to the prior art, is precluded. Substantially higher beam current densities can be obtained without adversely affecting the service life of the cathode. This can also be used to draw the necessary electron beam currents from smaller cathode areas. The spot size of the cathode spot determines the beam focusing quality on the display screen. The picture definition is increased throughout the screen. As, in addition, the cathodes age more slowly, picture brightness and picture definition can be maintained at a high level throughout the service life of the tube. Resolution and brightness of the CRT are improved. The operating temperature of the cathode can be maintained at a lower level without adversely affecting brightness and resolution.

Within the scope of the invention it is preferred that the sintering inhibitor is selected from the group formed by silicon oxides, niobium oxides, aluminum oxides, zirconium oxides and magnesium oxide.

It is particularly preferred to use ZrO₂ as the sintering inhibitor. ZrO₂ accumulates at the grain boundaries and reduces diffusion through the grain boundaries and along the grain boundaries. As a result, further grain growth is hampered and the originally porous structure of the electron-emitting material remains in tact.

In comparison with the prior art, the invention enables advantageous effects to be achieved if the sintering inhibitor is composed of aluminum sesquioxide. By virtue thereof, the barium emission becomes more uniform both locally and in time. Oxide cathodes having a higher direct-current loading capacity and a longer service life are obtained.

In comparison with the prior art, the invention enables particularly advantageous effects to be achieved if the electron-emitting material is doped with a metal ion with an ionic valence≠2.

Doping with ions having a higher or lower ionic valence than that of the alkaline earth elements causes vacancies and interstitial sites to be generated in the crystal lattice of the electron-emitting material and hence leads to an increase of the conductivity of the electron-emitting material. The vacancies and interstitial sites thus generated, however, also simultaneously lead to an increase of the diffusion rate in the electron-emitting material and hence cause sintering to be accelerated.

In particular small trivalent ions, for example yttrium(III) are known to improve the conductivity of the electron-emitting material. It has also been found, however, that they cause a particular increase of the sintering rate of the electron-emitting materials.

Therefore, the use of a sintering inhibitor in an oxide cathode doped with ions having an ionic valance≠2 is particularly effective.

Within the scope of the invention it may be preferred that the electron-emitting material is doped with a metal ion selected from the trivalent ions of lanthanum, cerium, praseodymium, neodymium, samarium, europium, gadolinium, terbium, dysprosium, holmium, erbium, thulium, ytterbium and lutetium and the quadrivalent ion of thorium.

With this type of cathode, the insensitivity to poisoning, in particular poisoning by oxygen, is to be emphasized. Said type of cathode exhibits a uniform emission and can be reproducibly manufactured. The observed tendency of these metal ions towards enhancing the co-sintering of the electron-emitting material is effectively counteracted by the combination with the sintering inhibitor in accordance with the invention.

In accordance with a preferred embodiment of the invention, the electron-emitting material further comprises metal particles of a metal selected from the group formed by yttrium, scandium, europium, terbium, zirconium, titanium and hafnium, to improve the conductivity.

It is particularly preferred to add metal particles in a quantity in the range of 50 ppm to 300 ppm.

The invention also relates to an oxide cathode comprising a cathode carrier with a cathode base of a cathode metal and a cathode coating of an electron-emitting material comprising an alkaline earth oxide, selected from the group formed by the oxides of calcium, strontium and barium, and a sintering inhibitor.

These and other aspects of the invention will be apparent from and elucidated with reference to the embodiment(s) described hereinafter.

In the drawing:

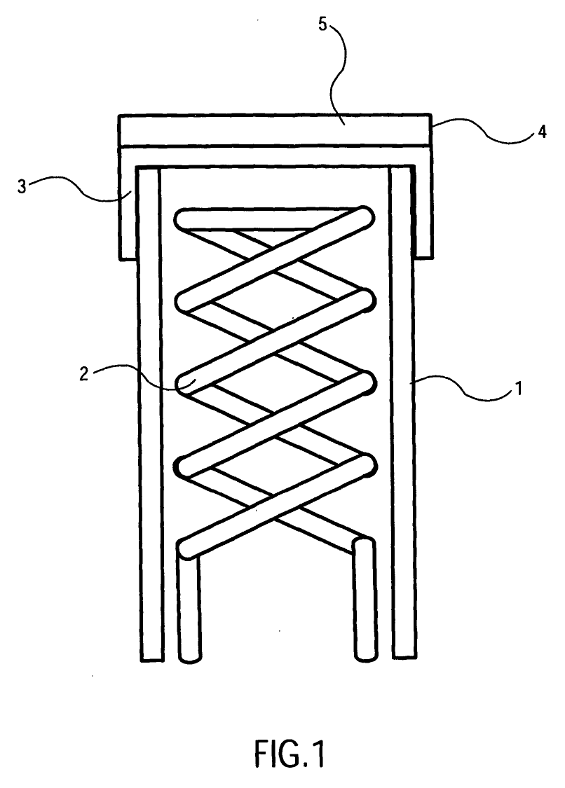

FIG. 1 is a diagrammatic cross-sectional view of an embodiment of the cathode in accordance with the invention.

A vacuum tube comprises an electron beam-generating system which customarily includes an arrangement of one or more oxide cathodes. An oxide cathode in accordance with the invention comprises a cathode carrier with a cathode base and a cathode coating. The cathode carrier includes the heater and the base for the cathode body. For the cathode carrier use can be made of the constructions and materials known from the prior art.

In the embodiment of the invention shown in FIG. 1, the oxide cathode comprises a cathode carrier, i.e. a cylindrical tube 1, wherein the heating wire 2 is inserted, a cap 3 forming the cathode base, and a cathode coating 5 which represents the actual cathode body 4.

Customarily, the material used for the cathode base is a nickel alloy. Said nickel alloy may be composed of, for example, nickel with an alloy constituent of an activator element having a reducing effect selected from the group formed by silicon, magnesium, aluminum, tungsten, molybdenum, manganese and carbon.

The cathode coating comprises an electron-emitting material. The main constituent of the electron-emitting material is an alkaline earth oxide, preferably barium oxide, along with calcium oxide or/and strontium oxide. They are used as a physical mixture of alkaline earth oxides or as binary or ternary mixed crystals of the alkaline earth metal oxides. Preferably, use is made of a ternary alkaline earth mixed crystal oxide of barium oxide, strontium oxide and calcium oxide, or a binary mixture of barium oxide and strontium oxide.

The cathode coating further comprises a sintering inhibitor. The inhibitor effect can be brought about by means of various mechanisms:

The sintering inhibitor has a passivating effect due to the formation of coherent covering layers on the grain boundaries.

The sintering inhibitor forms a separate phase that separates the grain boundaries of the sintering phase.

The sintering inhibitor influences the ratio of free surface energy to grain boundary energy.

The sintering inhibitor reduces the speed of the grain boundary diffusion with respect to the speed of the intra-grain diffusion.

In particular compounds of the group formed by silicon oxides, niobium oxides, aluminum oxides, zirconium oxides and magnesium oxides act as a regulator and inhibitor with respect to the grain growth of the electron-emitting material of the oxide cathode.

It is particularly preferred that the sintering inhibitor is composed of zirconium oxide.

It may also be preferred that the sintering inhibitor is composed of aluminum sesquioxide. This enables the grain growth to be substantially precluded, in particular in the temperature and time interval up to the formation of a passivating intermediate layer.

In accordance with a preferred embodiment, the electron-emitting material contains yttrium to improve the electric conductivity.

In accordance with yet another preferred embodiment, the electron-emitting material is doped with a trivalent lanthanoid metal or quadrivalent thorium so as to reduce the so-termed “poisoning” by oxygen. They preclude the partial deactivation of the electron-emitting material by oxygen, water vapor and other gases.

Preferably, this doping is present in a quantity in the range of 120 to maximally 500 ppm. The ions of said lanthanoid metals, such as lanthanum, cerium, praseodymium, neodymium, samarium, europium, gadolinium, terbium, dysprosium, holmium, erbium, thulium, ytterbium and lutetium as well as thorium occupy lattice sites or interstitial sites in the crystal lattice of the alkaline earth metal oxides.

The reason why the electron-emitting material is preferably doped with trivalent ions or quadrivalent ions selected from the group formed by lanthanum, cerium, praseodymium, neodymium, samarium, europium, gadolinium, terbium, dysprosium, holmium, erbium, thulium, ytterbium and lutetium as well as thorium is that their ion radii of >93 ppm are comparable to those of bivalent barium and strontium. These ions can occupy the lattice sites of barium in the host lattice of the alkaline earth oxides, and doping of the barium oxide lattice takes place without substantial lattice deformations.

What is characteristic of the electron-emitting coating of the oxide cathode in accordance with the invention is its electric conductivity, which ranges from 3*10⁻³ Ω⁻¹cm⁻¹ to 12.5*10⁻³ Ω⁻¹cm⁻¹ in the temperature range corresponding to the customary conditions in a cathode ray tube. By virtue of the controlled conductivity of the cathode, service life-reducing overheating or underheating is precluded.

In accordance with a particularly preferred embodiment, the electron-emitting material comprises, in addition to the oxide mixture in a weight ratio of calcium oxide:strontium oxide:barium oxide=1:1.25:6 or 1:12:22 or 1:1.5:2.5 or 1:4:6, also a doping with yttrium(III) ions in a quantity ≦0.3% by weight, preferably 50 to 300 ppm, to improve the conductivity of the electron-emitting material, a further doping with one of the trivalent ions of lanthanum, cerium, praseodymium, neodymium, samarium, europium, gadolinium, terbium, dysprosium, holmium, erbium, thulium, ytterbium and lutetium or with quadrivalent thorium(IV) to improve the conductivity, and an addition of zirconium dioxide as the sintering inhibitor in a quantity ≦0.5 wt. %.

To manufacture the raw mixture for the cathode coating, the carbonates of the alkaline earth metals calcium, strontium and barium are ground and mixed with a starting compound for the oxide of the lanthanoids lanthanum, cerium, praseodymium, neodymium, samarium, europium, gadolinium, terbium, dysprosium, holmium, erbium, thulium, ytterbium and lutetium or thorium oxide in the desired weight ratio. Preferably for the starting compounds of the oxides of the lanthanoid metals use is made of lanthanoid nitrates or lanthanoid hydroxides.

For an oxide cathode whose properties are improved by using a sintering inhibitor, it is desirable that the starting powder for the electron-emitting material already contains crystalline phases with the sintering inhibitor. This seems to be the only way to drastically limit, or entirely preclude, the grain growth of the crystallites right from the beginning of the sintering process.

For this purpose, in accordance with a modified embodiment of the method described above, the oxides of the water soluble salts are jointly precipitated by co-precipitation in the presence of at least one water-soluble starting compound of a sintering inhibitor in order to obtain an electron-emitting material which additionally comprises at least one sintering inhibitor.

In this manner, a very homogeneous mixture of the oxides is obtained during calcination, and the sintering inhibitor effect on the electron-emitting material or on the precursor thereof is maximized. At the same time, the mobility of the Ba particles on the oxidic surface is limited already during the heating-up time of the calcination step, as a result of which very small barium clusters are conserved. Finally, carbon dioxide, which escapes as a gas during the calcination process at approximately 350-400° C., brings about the formation of a secondary gas-pore structure, as is desired in the manufacture of the electron-emitting material.

Typically, the weight ratio of calcium carbonate:strontium carbonate:barium carbonate is 1:1.25:6 or 1:12:22 or 1:1.5:2.5 or 1:4:6.

The content of the metallic doping in the form of yttrium, scandium, europium, terbium, zirconium, titanium and hafnium typically is ≦0.3%; a content in the range of 50 to 100 ppm with respect to the electron-emitting mass is preferred.

The content of a doping comprising an oxide selected from the oxides of scandium, yttrium, lanthanum, cerium, praseodymium, neodymium, samarium, europium, gadolinium, terbium, dysprosium, holmium, terbium, thulium, ytterbium and lutetium is ≦3.0%. A doping in the range of 120 to maximally 500 ppm is preferred.

The sintering inhibitor is preferably added in a quantity ≦0.5%.

The raw mixture may additionally be mixed with a binder preparation. Said binder preparation may comprise water, ethanol, ethyl nitrate, ethyl acetate or diethyl acetate as the solvent.

The raw mixture for the cathode coating is then applied to the carrier by brushing, dip coating, cataphoretic deposition or spraying. The coated cathode is built into the cathode ray tube. During the evacuation of the cathode ray tube, the cathode is formed. By heating to a temperature in the range of approximately 650 to 1100° C., the alkaline earth carbonates are converted to the alkaline earth oxides, thereby releasing CO and CO₂, resulting in the formation of a porous sintered body. Of essential importance in this conversion process is the crystallographic change due to mixed crystal formation, which is a prerequisite for a good oxide cathode. After this firing of the cathode, an activation process is carried out which serves to supply excess elementary alkaline earth metal, which is intercalated in the oxides. Said excess alkaline earth metal is formed by reduction of alkaline earth metal oxide. In the actual reduction activation process, the alkaline earth oxide is reduced by the released CO or activator metal from the cathode base. In addition, a current activation takes place, which brings about the formation of the necessary free alkaline earth metal by electrolytic processes at high temperatures.

### EXAMPLE 1

As shown in FIG. 1, a cathode for a cathode ray tube in accordance with a first embodiment of the invention comprises a cap-shaped cathode base composed of an alloy of nickel with 0.05% by weight Mg, 0.035% by weight Al and 2.0% by weight W. The cathode base is situated at the upper end of a cylindrical cathode carrier (bushing), wherein the heating is mounted.

The cathode has a cathode coating on the upper side of the cathode base. To form said cathode coating, the cathode base is first subjected to a cleaning operation. Subsequently powders of starting compounds for the oxides are suspended in a solution of ethanol, butyl acetate and nitrocellulose.

The powder with the starting compounds for the oxides is composed, for example, of barium-strontium carbonate in a weight ratio of 1:1.25 with 70 ppm yttrium oxide. The mixture of the starting compounds comprises 100±15 ppm La₂O₃ as an additive to reduce the oxygen solid diffusion in the grains, which additive also contributes to an increase of the electric conductivity. The mixture comprises 0.25% ZrO₂ as the sintering inhibitor.

This suspension is sprayed onto the cathode base. The layer is formed first without and then with a current load at a temperature of 1000° C. to bring about alloying and diffusion between the cathode metal of the metal base and the metal particles.

The oxide cathode thus formed has a conductivity of 1*10⁻² Ω⁻¹cm⁻¹ at an operating temperature of 1050 K, a direct current loading capacity of 4 A/cm² at a service life of 20,000 h and an internal tube pressure of 2*10⁻⁹ bar.

### EXAMPLE 2

In a further embodiment of the invention, the cap-shaped cathode base is composed of an alloy of nickel with 0.12% by weight Mg, 0.09% by weight Al and 3.0% by weight W.

After its formation, the emitting oxide layer is composed of barium-strontium oxide in a weight ratio of 1:1 with 90 ppm yttrium oxide, and additionally comprises needle-shaped nickel particles to reduce the so-termed cut-off drift of the electron guns.

The mixture of starting compounds contains 90±15 ppm Nd₂O₃ as an additive to reduce the oxygen solid diffusion in the grains, which additive also contributes to an increase of the electric conductivity. Said mixture contains 0.2% Nb₂O₅ as the sintering inhibitor.

The oxide cathode thus formed has a conductivity of 1.2*10⁻² Ω⁻¹cm⁻¹ at an operating temperature of 1050 K, a direct current loading capacity of 4.5 A/cm² at a service life of 20,000 H and an internal tube pressure of 2*10⁻⁹ bar.

1. A vacuum tube equipped with at least one oxide cathode comprising a cathode carrier with a cathode base of a cathode metal and a cathode body with a cathode coating of an electron-emitting material that comprises an alkaline earth oxide, selected from the group formed by the oxides of calcium, strontium and barium, and a sintering inhibitor.

2. A vacuum tube as claimed in claim 1, characterized in that the sintering inhibitor is selected from the group formed by silicon oxides, niobium oxides, aluminum oxides, zirconium oxides and magnesium oxide.

3. A vacuum tube as claimed in claim 1, characterized in that the sintering inhibitor is composed of zirconium oxide.

4. A vacuum tube as claimed in claim 1, characterized in that the sintering inhibitor is composed of aluminum sesquioxide.

5. A vacuum tube as claimed in claim 1, characterized in that the electron-emitting material is doped with a metal ion having an ionic valence≠2.

6. A vacuum tube as claimed in claim 1, characterized in that the electron-emitting material is doped with a metal ion selected from the trivalent ions of lanthanum, cerium, praseodymium, neodymium, samarium, europium, gadolinium, terbium, dysprosium, holmium, erbium, thulium, ytterbium and lutetium and the quadrivalent ion of thorium.

7. A vacuum tube as claimed in claim 1, characterized in that the electron-emitting material additionally comprises an atomic metal selected from the group formed by yttrium, scandium, europium, terbium, zirconium, titanium and hafnium.

8. A vacuum tube as claimed in claim 7, characterized in that the electron-emitting material comprises the atomic metal in a quantity in the range of 50 ppm to 300 ppm.

9. An oxide cathode comprising a cathode carrier with a cathode base of a cathode metal and a cathode coating of an electron-emitting material comprising an alkaline earth oxide, selected from the group formed by the oxides of calcium, strontium and barium, and a sintering inhibitor.
